(19) United States
(12) Patent Application Publication
(10) Pub. No.: US 2009/0222492 A1
(43) Pub. Date: Sep. 3, 2009

(54) Logging Device and Recording Medium

(75) Inventors: Kenji Yamauchi, Tokyo (JP); Nobuhide Tsujimoto, Tokyo (JP)

Correspondence Address: BUCHANAN, INGERSOLL & ROONEY PC, POST OFFICE BOX 1404, ALEXANDRIA, VA, 22313-1404, US

(73) Assignee: MTSUBISHI ELECTRIC CORPORATION, Chiyoda-ku (JP)

(21) Appl. No.: 12/206,810

(22) Filed: Sep. 9, 2008

(30) Foreign Application Priority Data
Feb. 28, 2008 (JP) 2008-047877

(51) Int. Cl. G06F 12/16; G06F 17/30

(52) U.S. Cl. 707/202; 707/E17.005

(57) ABSTRACT

In the logging device, data at a check point in execution of an application program, a log output condition preliminarily set from outside, and a plurality of log output functions called at each check point are built in the application program; and at normal time, a log output is made only in case that an error level having been specified with a parameter of a log output function is coincident with the normal-time log output condition, and in case that the error level coincident with a trigger level arises, a detailed log at the error level coincident with the abnormal-time log output level is outputted.

### BACKGROUND OF THE INVENTION

1. Field of the Invention

The present invention relates to a logging device and a recording medium for logging data in real time at a check point in execution of an application program.

2. Description of the Related Art

There has been already proposed a logging device which is arranged so that a logging function is built in an application program, a section, or a section and a fetch condition is set as necessary with a parameter, only a necessary data is saved in a memory, and at the time of searching, a section, or a section and a search condition is specified to file and output only a necessary data, and in which only a necessary data among the data at a check point of the application program in operation on line is fetched, as well as only a necessary data is retrieved and outputted (refer to, for example, the Japanese Patent Publication (unexamined) No. 2001-318809).

The application disclosed in the above-mentioned Japanese Patent Publication (unexamined) No. 318809-2001 is an application program for making a variety of business operations (for example, on-line business operations such as purchase service of products), and in which a logging function that makes logging of data at a check point based on a parameter is built. The logging function is a function that is built in the application, and in which data at a check point is outputted when it is coincident with the section and the logging condition having been specified with a parameter, and no data at a check point is outputted when it is not coincident therewith.

### SUMMARY OF THE INVENTION

In the above-mentioned conventional logging device, however, processing is made so that on the occasion of calling a log output function, only one error level is specified; and only in the case that the specified error level is not less than a log output level having preliminarily been determined, a log output is made. Therefore, only one determination condition of whether or not a log output is made is given, and switching of the log output level has to be manually made each time by an operator from a setting change screen. Accordingly, at the time of occurrence of any abnormality of a system, after the occurrence of an abnormal state, an investigator has arrived at the site and switched a log output level from a general log to a detailed log, thus detailed logs from the occurrence of the abnormal state to the above-mentioned switching cannot be obtained. Furthermore, in case that a detailed log is outputted at all times, a problem exists in that a log file size becomes large.

The present invention has been made to solve the above-mentioned problems, and has an object of providing a logging device in which while the capacity of a log file is suppressed, at the time of occurrence of abnormality, a log output level is automatically changed, and detailed information immediately after or just before the occurrence of the abnormal state can be obtained.

To accomplish the foregoing object, the present invention provides a logging device for logging in real time data at a check point in execution of an application program, in which a log output condition that has preliminarily been externally set, and a plurality of log output functions that are called at each check point are built in the mentioned application program; and at normal time, a log output is made only in the case that an error level having been specified with a parameter of a log output function is coincident with the normal-time log output condition, and in the case that an error level that is coincident with a trigger level arises, a detailed log at the error level that is coincident with the abnormal-time log output level is outputted.

According to the invention, on the occasion of logging in real time data at a check point in execution of an application program, at normal time, a log output is temporarily stored in a cache, and at the time of the occurrence of abnormality, a log output level is automatically switched to output a present abnormal-time log or to output a temporarily stored log just before as well as the present abnormal-time log. As a result, there are such advantages as being capable of obtaining detailed information immediately after or just before the occurrence of an abnormal state while the capacity of a log file is suppressed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a system arrangement diagram according to a first embodiment of the present invention.

FIG. 2 is a flowchart of a log output function of the first embodiment according to the present invention.

FIG. 3 is a processing example of an application using a log output function in a logging device according to the first embodiment of the invention.

FIG. 4 are diagrams illustrating a call example and a log output example of a log output function.

FIG. 5 is a system arrangement diagram of a second embodiment according to the invention.

FIGS. 6A and B are flowcharts each showing a log output function according to the second embodiment of the invention.

FIG. 7 illustrates a processing example of an application using a log output function in a logging device according to the second embodiment of the invention.

FIG. 8 is a system arrangement diagram of a third embodiment according to the invention.

FIGS. 9A and B are flowcharts each showing a log output function according to the third embodiment of the invention.

FIG. 10 illustrates a processing example of an application using a log output function in a logging device according to the third embodiment of the invention.

### DESCRIPTION OF THE PREFERRED EMBODIMENTS

### Embodiment 1

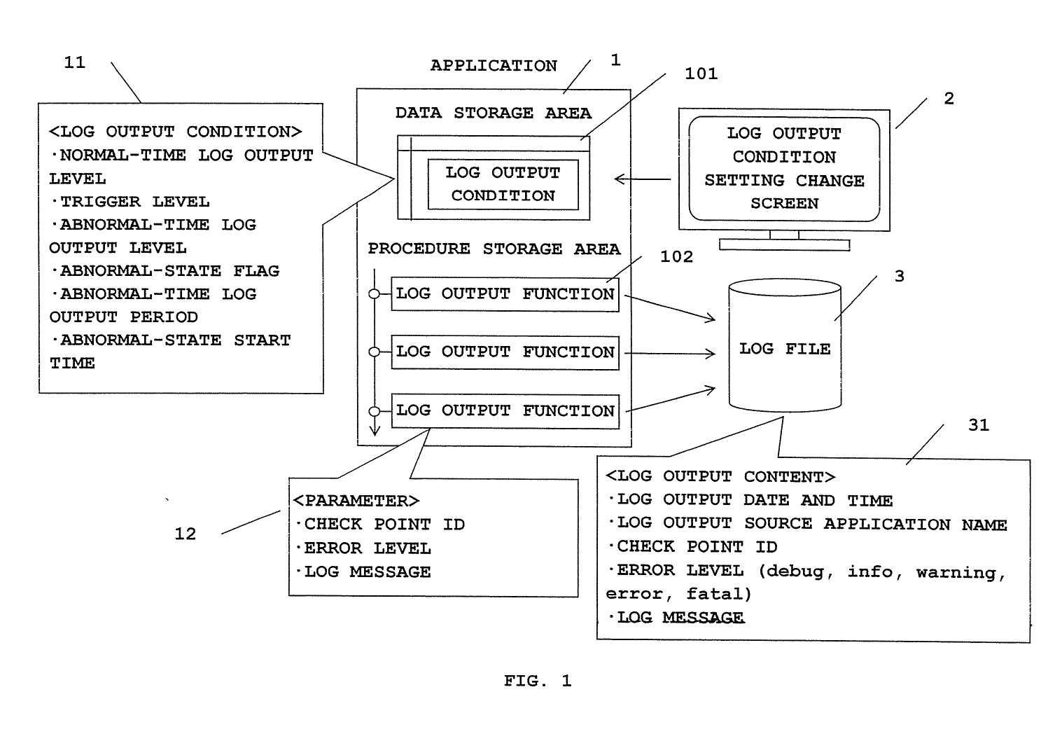

FIG. 1 is a system arrangement diagram in a logging device according to a first embodiment of the present invention. With reference to FIG. 1, reference numeral 1 designates an application that is installed on an electronic computer system, and contains a log output condition 101 that is stored in a data storage area and a plurality of log output functions 102 to be called out at each check point that is stored in a procedure storage area. Numeral 2 designates a setting change screen with which the log output condition 101 of the above-mentioned application 1 is externally set. Numeral 3 designates a log file in which a log data having been output from the above-mentioned log output functions 102 is temporarily stored. Numeral 31 designates a specific content of a log data to be outputted to the above-mentioned log file. Numeral 11 designates contents of the log output condition 101. Numeral 12 designates contents of a parameter to be specified in the above-mentioned log output function 102.

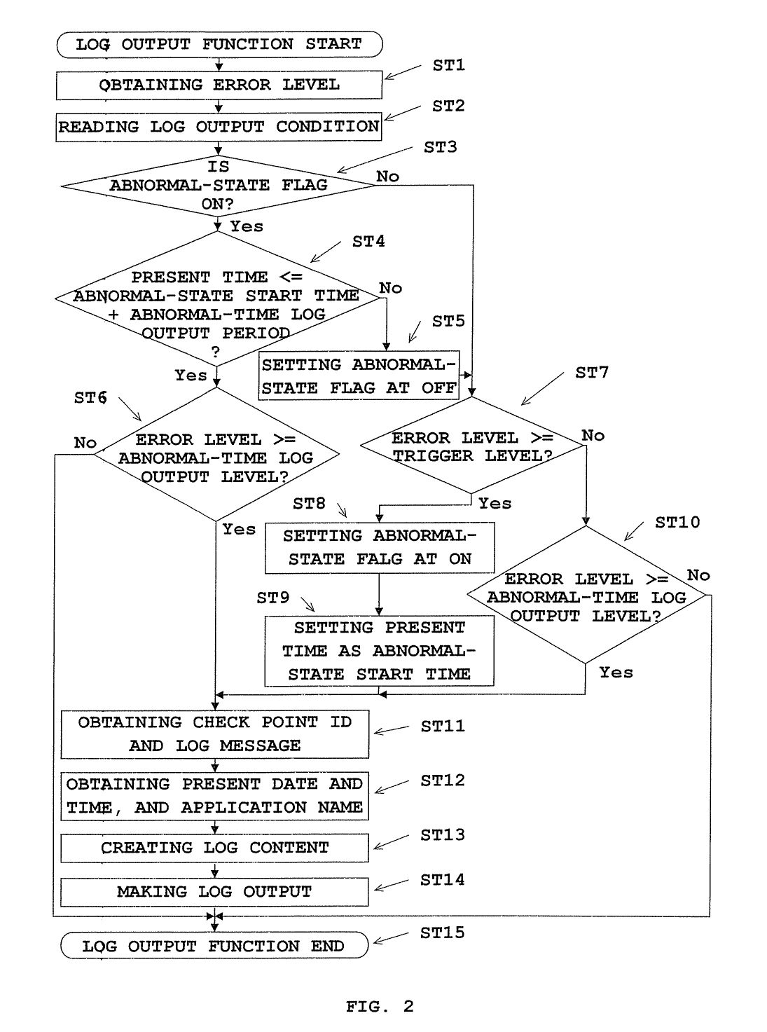

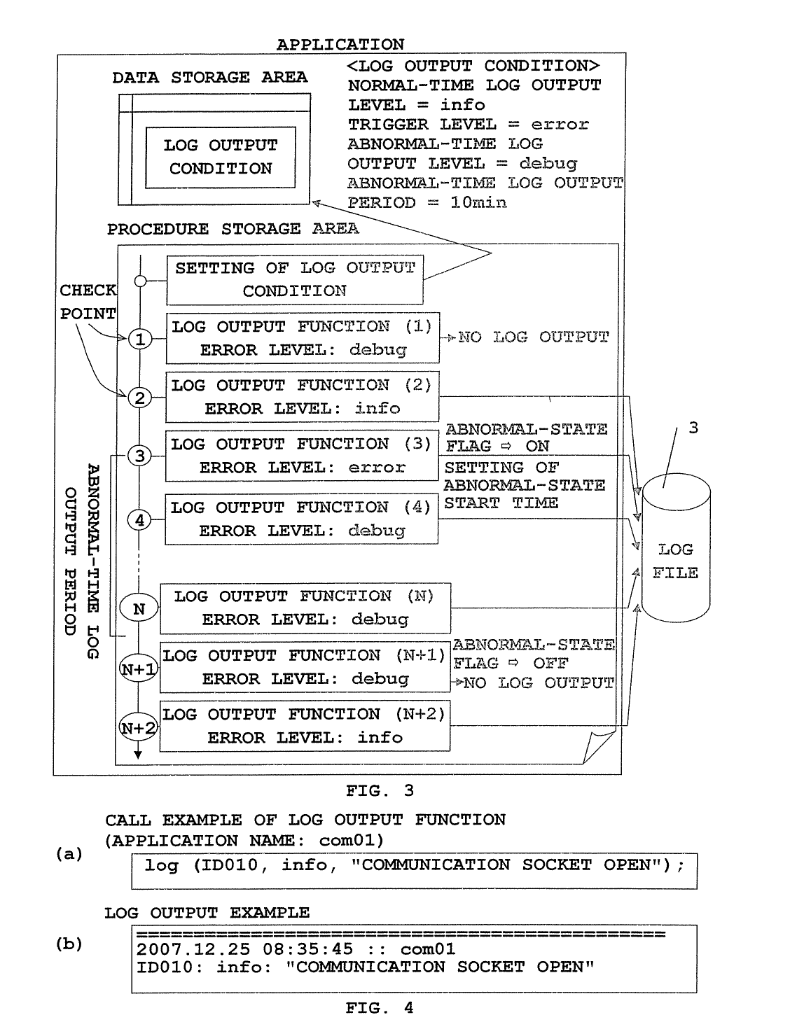

FIG. 2 is a flowchart illustrating the flow of processing of a log output function in the logging device according to the first embodiment of this invention. FIG. 3 illustrates an example of processing of an application using the log output function of FIG. 2. A normal-time log output level in the log output condition 11 illustrated in FIG. 1 shows an error level to be a log output condition in the normal state. The error level is a level showing the degree of importance and the degree of details, and can be thought to be, for example, debug, info, warning, error, and fatal. In the invention, since comparison between the error level that is specified with a parameter of a log output function and the error lever in a log output condition has to be made, for example, digitalization with 8-bit data is done, and numerical values of increasing in the order of debug<info<warning<error<fatal are defined, thereby enabling to determine whether or not there is a coincidence between the conditions based on a magnitude correlation of the values.

Debug, in this case, is a detailed trace log showing in detail processing situations of an application. Info is a general log showing rough processing situations. Warning is the level at which a slight problem arises in processing of the application, but this processing can continue. Error is a medium fault condition in which because the processing cannot continue, it is skipped, but the other processing can continue. Fatal shows a serious fault condition in which processing of the application cannot continue.

A trigger level is a log output level at which an abnormal state is determined. An abnormal-time log output level shows a log output level to be outputted when the abnormal time is determined with a trigger level detection. An abnormal-state flag is a flag showing that the abnormal state continues. An abnormal-time log output period shows a period during which the abnormal state continues. An abnormal-state start time shows a time when the abnormal state is detected, and the abnormal-state flag is put up.

Further, in the parameter 12 of the log output function 102, a check point ID is a symbol or a number uniquely showing the place of calling a log output function in the flow of processing of the application, and can be thought to be a serial number of a log output function, the number of lines of an application processing and the like. An error level is to show the degree of importance or the degree of details of information to be outputted with this log output function, and can be thought to the same error level (debug, info, warning, error, fatal) as that of the above-mentioned log output condition 11. Only in the case that the above-mentioned error level is coincident with the condition of the normal-time log output level in the log output condition 11, a log is outputted to the log file 3 and temporarily stored therein. A log message is the content of information intended to be log-outputted.

Furthermore, in the log output content 31 to be outputted to the log file 3, a log output date and time shows day and time when a log is outputted. A log output source application name is a name of an application that outputs this log, and is information to be added in an internal part of the log output function. A check point ID is a check point ID to be passed with the parameter 12 of a log output function. An error level is a level to be passed with the parameter 12 of a log output function, and can be thought to be, for example, debug, info, warning, error, and fatal. A log message is a message to be passed with the parameter 12 of a log output function.

FIG. 4(a) illustrates a call example of a log output function, and ID010 is an example of a check point ID name, info is an example of error level, and “communication socket open” is an example of a log message. In addition, FIG. 4(b) illustrates an example of log output content, and indicates the log output content in the order of log output date and time, log output source application name (com01) checkpoint ID name, and error level and log message.

Now, with reference to FIGS. 1 to 4, operation of the logging device according to the invention is described. At the time of executing the application 1, the log output condition 11 has preliminarily been set using the log output condition setting screen 2. In this embodiment, as illustrated as the log output condition of FIG. 3, shown is an example in which the normal-time log output level is specified to be info, the trigger level is specified to be error, the abnormal-time log output level is specified to be debug, and the abnormal-time log output period is specified to 10 minutes. When the execution of an application program is started, first a log output function (1) is called at the error level=debug at a check point 1 of FIG. 3. The operation of the log output function at this time is hereinafter described referring to the flowchart of FIG. 2.

In Step ST1 of FIG. 2, an error level (debug) is obtained from the parameter 12 of a log output function, to go to Step ST2. In Step ST2, the log output condition 11 is read from the data storage area 101 of the application 1, to go to Step ST3. In Step ST3, it is determined whether or not the abnormal-state flag of the log output condition 11 is ON. In the case of ON, the operation goes to Step ST4; and in the case of OFF, the operation goes to the Step ST7. In Step ST4, it is determined whether or not a present time is on and after the abnormal-state start time+abnormal-time log output period in the log output condition 11. When the present time is smaller than the abnormal-state start time+the abnormal-time log output period in the log output condition 11, that is, in the case that it is determined to be in the period of outputting the abnormal-time log, the operation goes to Step ST6; and in the case that it is determined that the period of outputting the abnormal time log has been ended, the operation goes to Step ST5.

In Step ST6, it is determined whether or not the error level having been specified with the parameter of the log output function is not less than the abnormal-time log output level. In the case of being coincident with the determination condition, the operation goes to Step ST11; and in the case of not being coincident therewith, the operation goes to Step ST5, in which the log output function is ended. In Step ST11, a check point ID and a log message are obtained from the parameter 12 of the log output function, to go to Step ST12. In Step ST12, a present date and time, and an application name are obtained, to go to Step ST13. In Step ST13, a log content is created, to go to Step ST14. In Step ST14, a log message is outputted to the log file 3, to go to Step ST15, in which the operation of the log output function is ended.

In Step ST5, an abnormal-state flag of the log output condition 11 is set to be OFF, to go to Step ST7. In Step ST7, it is determined whether or not the error lever having been obtained from the parameter 12 of the log output function is coincident with the trigger level of the log output condition 11. In the case of being coincident, the operation goes to Step ST8; and in the case of not being coincident, the operation goes to Step ST10. In Step ST8, the abnormal-state flag is set to be ON, to go to Step ST9. In Step ST9, the present time is set to the abnormal-state start time of the log output condition 11, to go to Step ST11. In Step ST10, it is determined whether or not the error level is coincident with the normal-time log output level. In the case of being coincident, the operation goes to Step ST11; and in the case of not being coincident, the operation goes to Step ST15, in which the processing of the log output function is ended.

At the check point 1 of FIG. 3, since the log output function (1) is called at the error level=debug, in the flowchart of FIG. 2, the processing proceeds in the order of Step ST1→Step ST2→Step ST3 (abnormal-state flag is OFF)→Step ST7 (since the error level is debug and the trigger level is error, it is No)→Step ST10 (since the error level is debug and the normal-time log output level is info, it is No)→Step ST15. Due to that the abnormal stat flag is OFF, as well as the error level (debug) is not coincident with the normal-time log output condition (info) or the trigger level (error), no log output is made.

At a check point 2 of FIG. 3, since a log output function (2) is called at the error level=info, in the flowchart of FIG. 2, the processing proceeds in the order of Step ST1→Step ST2→Step ST3→Step ST7 (since the error level is info and the trigger level is error, it is No)→Step ST10 (since the error level is info and the normal-time log output level is info, it is Yes)→Step ST11 Step ST12→Step ST13→Step ST14→Step ST15. Due to that the error level (info) is coincident with the normal-time log output condition (info), a log output is made and is stored in the log file 3.

At a check point 3 of FIG. 3, since a log output function (3) is called at the error level=error, in the flowchart of FIG. 2, the processing proceeds in the order of Step ST1→Step ST2→Step ST3→Step ST7 (since the error level is error and the trigger level is error, it is Yes)→Step ST8→Step ST9→Step ST11→Step ST12→Step ST13→Step ST14→Step ST15. Due to that the error level (error) is coincident with the trigger level, the abnormal-state flag is ON (Step ST8), the present time is set to the abnormal-state start time (Step ST9), and a log output is made.

Then, in a check point 4 of FIG. 3, a log output function (4) is called at the error level=debug. In case of normal time, since debug is not coincident with the condition of info of the normal-time log output level, no log output is made. However, since the abnormal-time state flag is ON as well as debug is coincident with the abnormal-state log output level (debug), the processing of automatically making a detailed log output is operated at the time of the occurrence of abnormality to make a log output. That is, in the flowchart of FIG. 2, the processing proceeds in the order of Step ST1→Step ST2→Step ST3 (abnormal-state flag is ON)→Step ST4 (in the period of outputting the abnormal-time log)→Step ST6 (since the error level is debug and the abnormal-time log is debug, it is Yes)→Step ST11→Step ST12→Step ST13→Step ST14→Step ST15.

In the case that the abnormal-time log output period of the log output condition 11 continues up to a check point N of FIG. 3, since the log of which error level is not less than debug is coincident with the abnormal-time log output condition from the check point 3 to the check point N, a detailed log is outputted. When the abnormal-time log output period ends at between the check point N and the check point N+1, that is, in the case that the time at the check point N+1 is on and after the abnormal-state start time+the abnormal-time log output period, in the flowchart of FIG. 2, operation proceeds in the order of Step ST1→Step ST2→Step ST3→Step ST4→Step ST5→Step ST7 (since the error level is debug and the trigger level is error, it is No)→Step ST10 (since the error level is debug and the normal-time log output level is info, it is No)→Step ST15. Thus, the abnormal-state flag is OFF, and no log output is made. In a check point N+2 of FIG. 3, since the error level=info is coincident with the log output condition at normal time, a log output is made in the same manner as at the check point 2.

As described above, according to this first embodiment, due to that at normal time, a log output is made only in the case that the error log having been specified with a parameter is coincident with the normal--time log output condition, small amounts of log outputs are made at normal time. In addition, in the case that the error level that is coincident with the trigger level arises, the log at an error level that is coincident with the abnormal-time log output level is outputted, and automatically more detailed logs will be outputted. That is, due to that at normal time, a log output amount is suppressed to suppress the capacity of log files; and at the occurrence of abnormality, such an automatic switching as to output a detailed log is made, detailed log outputs can be obtained immediately after the occurrence of abnormality, and thus maintainability of software is considerably improved.

### Embodiment 2

In the foregoing first embodiment, although the detailed logs can be obtained immediately after the occurrence of abnormality, in order to detect the cause of the occurrence of abnormality, there are some cases in which examination of detailed logs just before the occurrence of abnormality is required. This second embodiment was made to solve such problem, and is arranged so that by recording the log just before the occurrence of abnormality in a cache, continuous detailed logs continuing from just before the occurrence of abnormality to immediately after the occurrence of abnormality can be outputted.

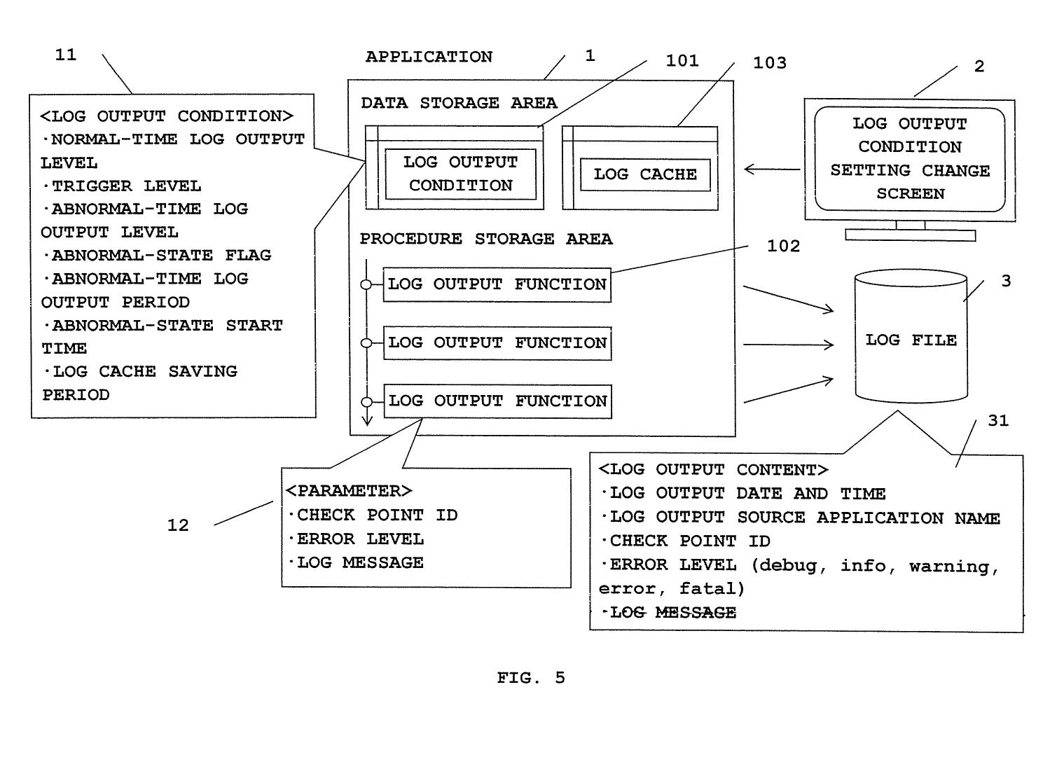

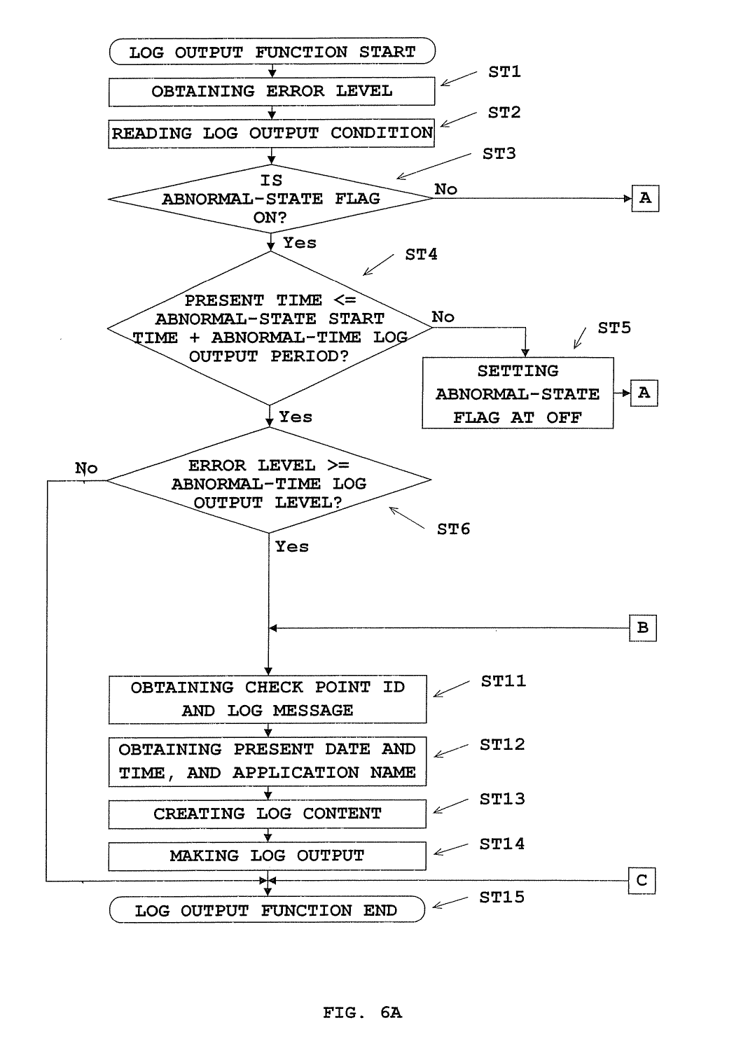

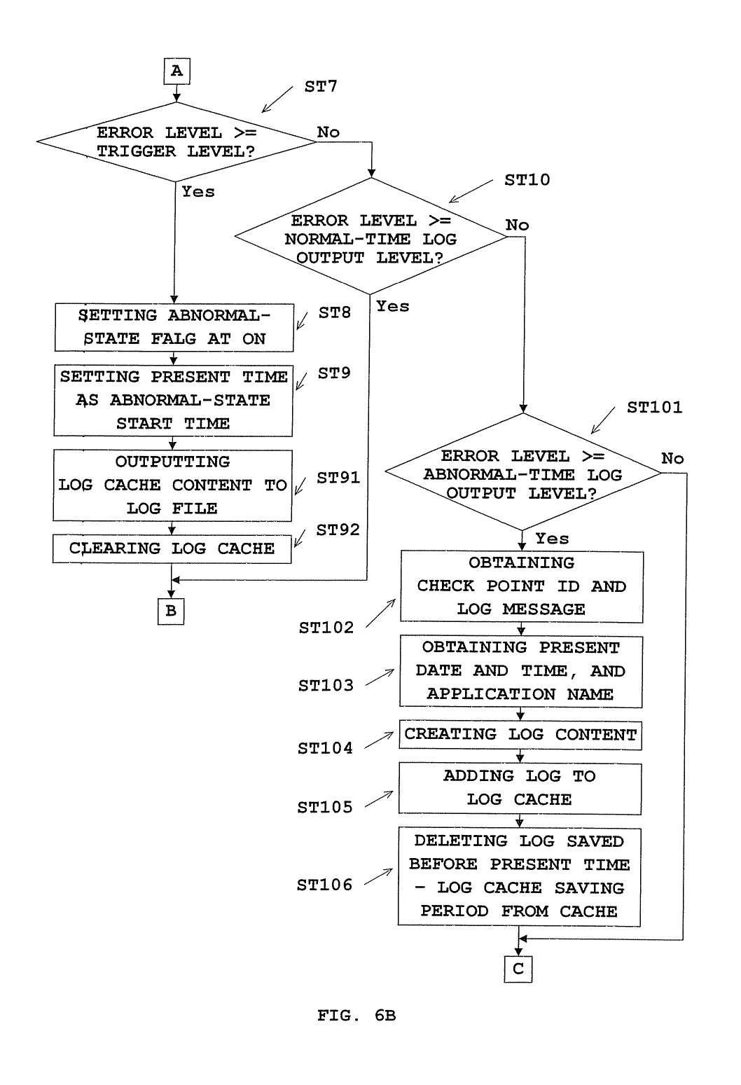

FIG. 5 is a system arrangement diagram in a logging device according to the second embodiment of the invention, and corresponds to FIG. 1. In FIG. 5, the same reference numerals refer to like parts as those in FIG. 1. To the log output conditions 11, a log cache saving period is added. The log cache saving period is a parameter indicating a saving period for saving a log just before the occurrence of abnormality in the cache for a predetermined period. Furthermore, numeral 103 designates a log cache storage area.

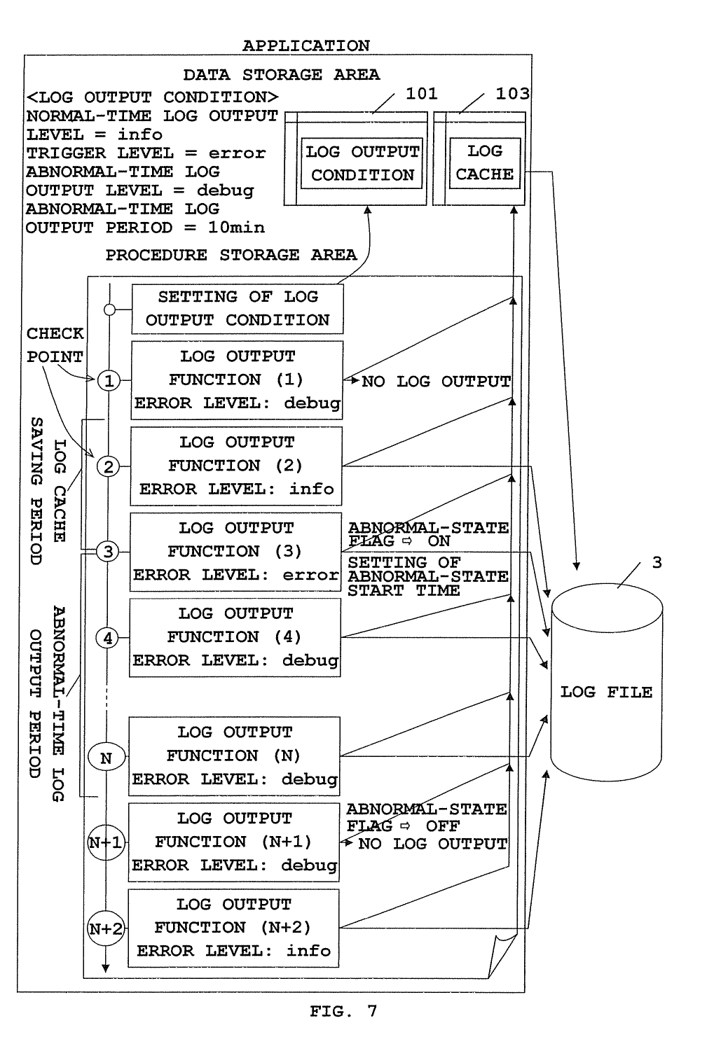

FIGS. 6A and B are flowcharts each illustrating the flow of a log output function in the logging device according to the second embodiment of the invention. FIG. 7 illustrates a processing example of an application using the log output function in the logging device according to the second embodiment of this invention.

With reference to FIGS. 5 to 7, the operation of the logging device according to the invention is hereinafter described. At the time of executing the application 1, the log output condition 11 has preliminarily been set from the log output condition setting screen 2 in the same manner as in the foregoing first embodiment.

In FIG. 7, for example, the normal-time output level is specified to be info, the trigger level is specified to be error, the abnormal-time log output level is specified to be debug, the abnormal-time log output period is specified to be 10 minutes, and the log cache saving period is specified to be 3 minutes. The operation of log output function when a log output function (1) is called at the error level=debug at a checkpoint 1 of FIG. 7 is described referring to the flowcharts of FIGS. 6A and B. In Step ST1 of FIG. 6A, the error level (debug) is obtained from the parameter of a log output function, to go to Step ST2. In Step ST2, the log output condition 11 is read from a data storage area 101 of the application 1, to go to Step ST3.

In Step ST3, it is determined whether or not the abnormal-state flag of the log output condition 11 is ON. In the case of ON, the operation goes to Step ST4; and in the case of OFF, the operation goes to Step ST7. In Step ST4, it is determined whether or not the present time is on and after the abnormal-state start time+abnormal-time log output period in the log output condition 11. In the case that it is determined to be in the period of outputting an abnormal-time log, the operation goes to Step ST6; and in the case that it is determined that the period of outputting an abnormal-time log has been ended, the operation goes to Step ST5. In Step ST6, it is determined whether or not the error level having been specified with the parameter of a log output function is not less than the abnormal-time log output level. In the case of being coincident with the determination condition, the operation goes to Step ST11; and in the case of not being coincident, the operation goes to Step ST15, in which the log output function is ended.

In Step ST11, a check point ID and a log message are obtained from the parameter of a log output function, to go to Step ST12. In Step ST12, a present date and time, and an application name are obtained, to go to Step ST13. In Step ST13, a log content is created, to go to Step ST14. In Step ST14, the log message is outputted to a log file, to go to Step ST15, in which the log output function is ended. In Step ST5, the abnormal-state flag of the log output condition 11 is set to be OFF, to go to Step ST7. In Step ST7, it is determined whether or not the error level having been obtained from the parameter of the log output function is coincident with the trigger level of the log output condition 11. In the case of being coincident, the operation goes to Step ST8; and in the case of not being coincident, the operation goes to Step ST10.

In Step ST8, the abnormal-state flag is set to be ON, to go to Step ST9. In Step ST9, the present time is set to be the abnormal-state start time of the log output condition 11, to go to Step ST91. In Step ST91, all contents of the log cache are outputted to the log file, to go to Step ST92. In Step ST92, the log cache is cleared, to go to Step ST11. In Step ST10, it is determined whether or not the error level is coincident with the normal-time log output level. In the case of being coincident, the operation goes to Step ST11; and in the case of not being coincident, the operation goes to Step ST101.

In Step ST101, it is determined whether or not the error level is coincident with the abnormal-time log output level. In the case of being coincident, the operation goes to Step ST102; and in the case of not being coincident, the operation goes to Step ST15, in which the log output function is ended. In Step ST102, a check point ID and a log message are obtained from the parameter 12 of a log output function, to go to Step ST103. In Step ST103, a present date and time, and an application name are obtained, to go to Step ST104. In Step ST104, a log content is created, to go to Step ST105. In Step ST105, a log is added to the log cache, to go to Step ST106. In Step ST106, the log having been saved before the time to be obtained by subtracting the log file saving period from the present time is deleted from the log cache, to go to Step ST15, in which the log output function is ended.

At a check point 1 of FIG. 7, since the log output function (1) is called at the error level=debug, in the flowcharts of FIGS. 6A and B, the processing proceeds in the order of Step ST1→Step ST2→Step ST3→Step ST7 (since the error level is debug and the trigger level is error, it is No)→Step ST10 (since the error level is debug and the normal-time log output level is info, it is No)→Step ST101 (since the error level is debug and the abnormal-time log output level is debug, it is Yes)→Step ST102→Step ST103→Step ST104→Step ST105→Step ST106→Step ST15. Due to that the abnormal-state flag is OFF as well as the error level (debug) is not coincident with the normal-time log output condition (info) or the trigger level (error), no log output is made. However, since the error level is not less than the abnormal-time log output level, saving in the log cache is executed. At this time, the old log saved after the log cache saving period has passed is deleted from the cache (Step ST106).

At a check point 2 of FIG. 7, since a log output function (2) is called at the error level=info, in the flowcharts of FIGS. 6A and B, the processing proceeds in the order of Step ST1→Step ST2→Step ST3→Step ST7 (since the error level is info and the trigger level is error, it is No)→Step ST10 (since the error level is info and the normal-time log output level is info, it is Yes)→Step ST11→Step ST12→Step ST13→Step ST14→Step ST15. Due to that the error level (info) is coincident with the normal-time log output condition (info), a log output is made.

At a check point 3 of FIG. 7, since a log output function (3) is called at the error level=error, in the flowchart of FIGS. 6A and B, the processing proceeds in the order of Step ST1→Step ST2→Step ST3→Step ST7 (since the error level is error and the trigger level is error, it is Yes)→Step ST8→Step ST9→Step ST91→Step ST92→Step ST11→Step ST12→Step ST13→Step ST14→Step ST15. Due to that the error level (error) is coincident with the trigger level, the abnormal-state flag is ON, and the present time is set to be the abnormal-state start time. First, log cache content is outputted, the log cache content is cleared, and thereafter a log output is made.

Then, in a check point 4 of FIG. 7, a log output function (4) is called at the error level=debug. In case of normal time, since debug is not coincident with the condition of info of the normal-time log output level, no log output is made. However, since the abnormal-time state flag is ON as well as debug is coincident with the abnormal-state log output level, the processing of automatically making a detailed log output at the time of the occurrence of abnormality is operated to make a log output. That is, in the flowchart of FIGS. 6A and B, the processing proceeds in the order of Step ST1→Step ST2→Step ST3→Step ST4→Step ST6→Step ST11→Step ST12→Step ST13→Step ST14→Step ST15.

In the case that the abnormal-time log output period of the log output condition 11 continues up to a check point N of FIG. 3, since the log of which error level is not less than debug is coincident with the abnormal-time log output condition to the check point N, a detailed log is outputted. When the abnormal-time log output period ends between the check point N and the check point N+1, that is in the case that the time at the check point N+1 is on and after the abnormal-state start time+the abnormal-time log output period, in the flowchart of FIGS. 6A and B, the processing proceeds in the order of Step ST1→Step ST2→Step ST3→Step ST4→Step ST5→Step ST7→Step ST10→Step ST101→Step ST102→Step ST103→Step ST104→Step ST105→Step ST106→Step ST15. Therefore, although the abnormal-state flag is OFF, and no log output is made, saving in the log cache is executed.

At a check point N+2 of FIG. 7, since the error level=info is coincident with the log output condition at normal time, a log output is made in the same manner as at the check point 2.

According to the second embodiment as described above, since detailed log outputs just before the occurrence of abnormality can be made, detailed situations from just before the occurrence of abnormality to immediately after the occurrence of abnormality can be obtained, resulting in an advantage of further improved maintainability of software.

### Embodiment 3

In the foregoing second embodiment, although the detailed logs can be obtained just before the occurrence of abnormality, since the logs of various abnormal events are outputted to one log file, a problem exists in a complicated determination as to whether or not it is the log related to an abnormal event on which attention is focused. This third embodiment has been made to solve such problem, and is arranged so that logs can be outputted to separate log files for each abnormal event.

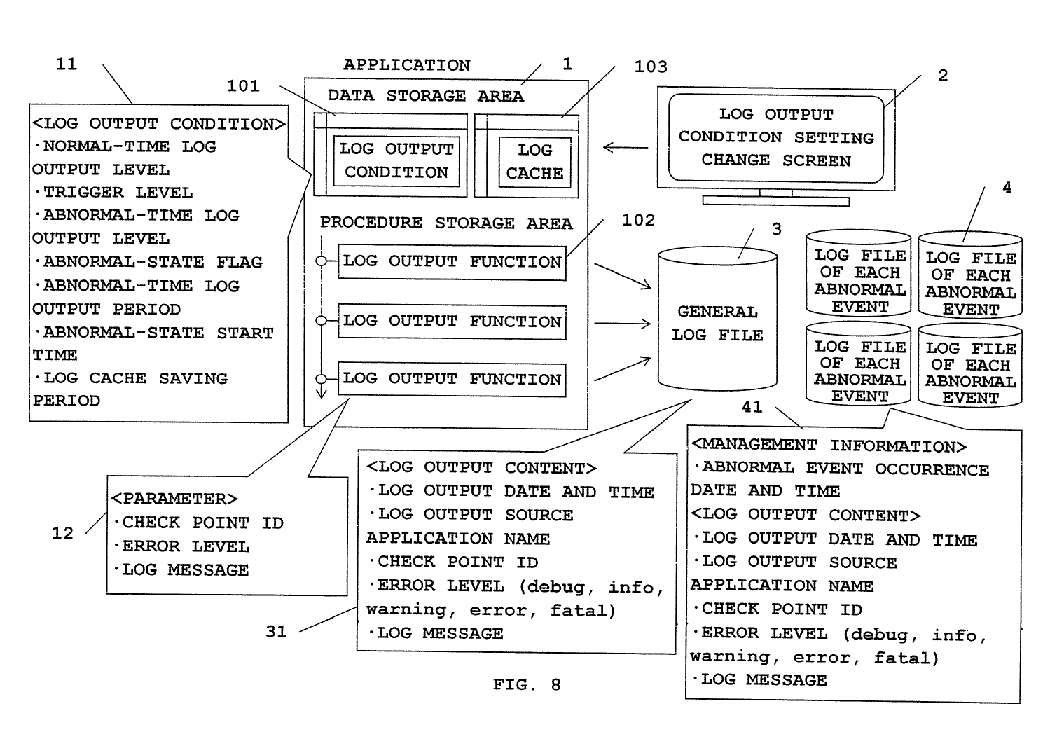

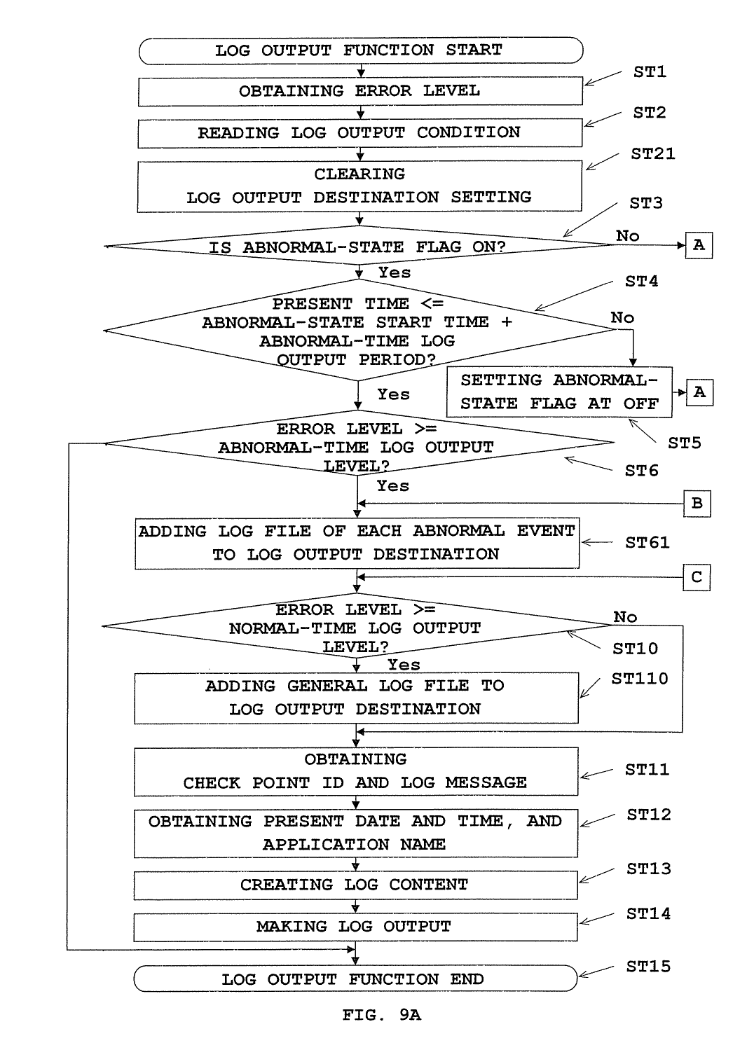

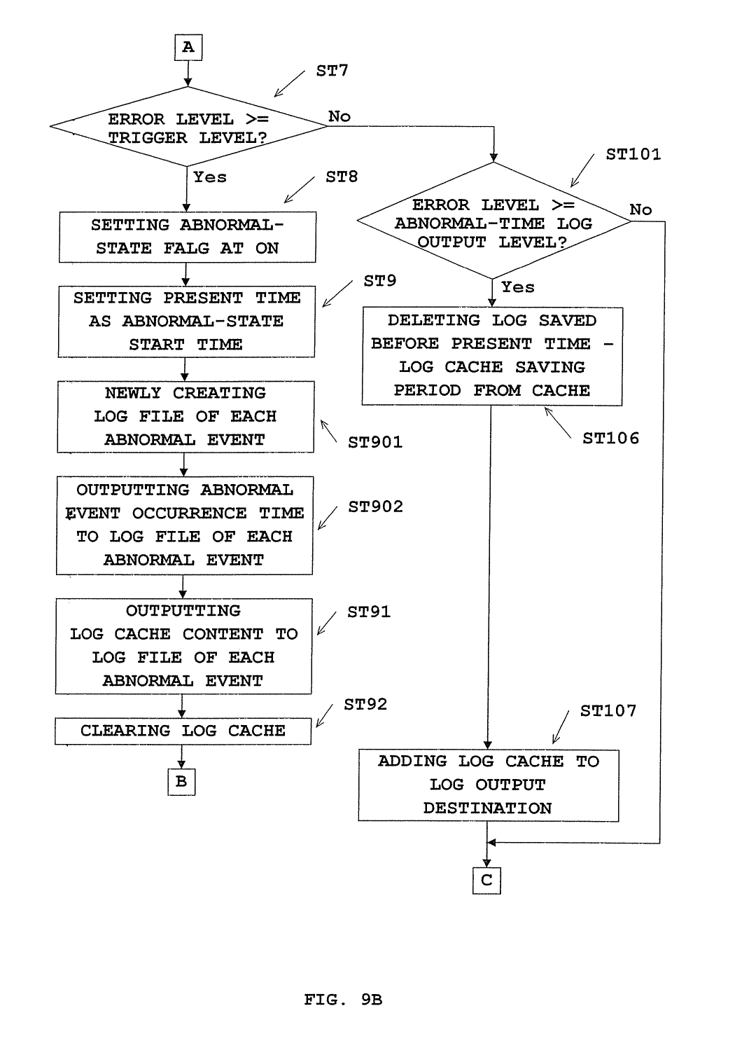

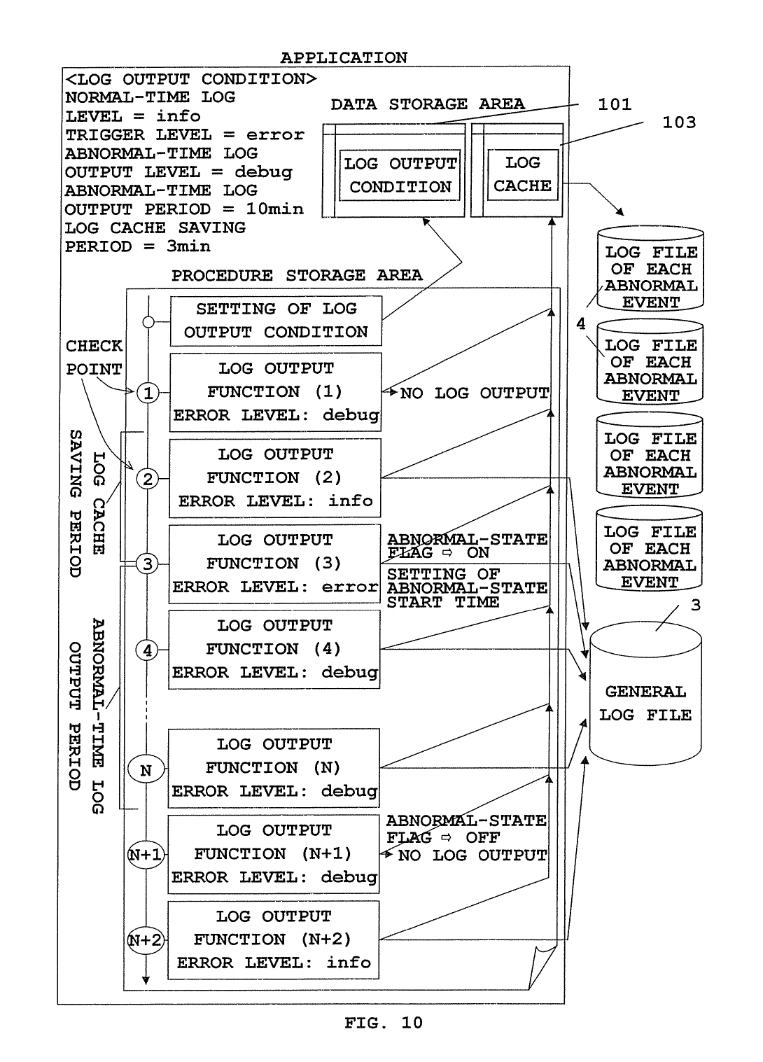

FIG. 8 is a system arrangement diagram in a logging device according to the third embodiment of the invention. In FIG. 8, the same reference numerals refer to like parts as those of FIG. 1. Numeral 4 designates a log file for each abnormal event. In a content 41, an abnormal event occurrence date and time are recorded at the head of the file. FIGS. 9A and B are flowcharts each illustrating the flow of processing of a log output function in the logging device according to the third embodiment of this invention. FIG. 10 is a processing example of an application using the log output function in the logging device according to the third embodiment of the invention.

With reference to FIGS. 8 to 10, operation of the logging device according to the invention is hereinafter described. At the time of executing the application 1, the log output condition 11 has preliminarily been set from the log output condition setting screen 2. In this embodiment, in the same manner as in the foregoing second embodiment, as is illustrated in FIG. 10, the normal-time output level is specified to be info, the trigger level is specified to be error, the abnormal-time log output level is specified to be debug, the abnormal-time log output period is specified to 10 minutes, and the log cache saving period is specified to be 3 minutes. The operation of log output function when a log output function (1) is called at the error level=debug at a check point 1 of FIG. 10 is now described referring to the flowchart of FIGS. 9A and B.

In Step ST1 of FIG. 9A, an error level (debug) is obtained from the parameter 12 of a log output function, to go to Step ST2. In Step ST2, the log output condition 11 is read from the data storage area 101 of the application 1, to go to Step ST21. In Step ST21, setting of a log output destination is cleared, to go to Step ST3. In Step ST3, it is determined whether or not the abnormal-state flag of the log output condition 11 is ON. In the case of ON, the operation goes to Step ST4; and in the case of OFF, the operation goes to the Step ST7. In Step ST4, it is determined whether or not a present time is on and after the abnormal-state start time+abnormal-time log output period in the log output condition 11. In the case of being determined to be in the period of outputting the abnormal-time log, the operation goes to Step ST6; and in the case that it is determined that the period of outputting the abnormal-time log has been ended, the operation goes to Step ST5.

In Step ST6, it is determined whether or not the error level having been specified with the parameter 12 of a log output function is not less than the abnormal-time log output level. In the case of being coincident with the determination condition, the operation goes to Step ST 61; and in the case of not being coincident, the operation goes to Step ST15, in which the log output function is ended. In Step ST61, a log file for each abnormal event is added to a log output destination, to go to Step ST10. In Step ST10, it is determined whether or not the error level is not less than the normal-time log output level. In the case of being coincident with the condition, the operation goes to Step ST110; and in the case of not being coincident therewith, the operation goes to Step ST11.

In Step ST110, a general log file is added to the log output destination, to go to Step ST11. In Step ST11, a check point ID and a log message are obtained from the parameter 12 of a log output function, to go to Step ST12. In Step ST12, a present date and time, and an application name are obtained, to go to Step ST13. In Step ST13, a log content is created, to go to Step ST14. In Step ST14, the log message is outputted to the log output destination, to go to Step ST15, in which the log output function is ended.

In Step ST5, an abnormal-state flag of the log output condition 11 is set to be OFF, to go to Step ST7. In Step ST7, it is determined whether or not the error level having been obtained from the parameter of a log output function is coincident with the trigger level of the log output condition 11. In the case of being coincident, the operation goes to Step ST8; and in the case of not being coincident, the operation goes to Step ST101. In Step ST8, the abnormal-state flag is set to be ON, to go to Step ST9. In Step ST9, the present time is set to the abnormal-state start time of the log output condition 11, to go to Step ST901.

In Step ST901, a log file for each abnormal event is newly created, to go to Step ST902. In Step ST902, the abnormal event start time is recorded at the head of the log file for each abnormal event, to go to Step ST91. In Step ST91, all contents of the log cache are outputted to the log file for each abnormal event, to go to Step ST92. In Step ST92, the log cache is cleared, to go to Step ST61. In Step ST61, the log file for each abnormal event is added to the log output destination, to go to Step ST10.

In Step ST101, it is determined whether or not the error level is not less than the abnormal-time log output level. In the case of being coincident with the determination condition, the operation goes to Step ST106. In the case of not being coincident, the operation goes to Step ST10. In Step ST106, the log having been saved before the time to be obtained by subtracting the log file saving period from the present time is deleted from the log cache, to go to Step ST107. In Step ST107, the log cache is added to the log output destination, to go to Step ST10.

At a check point 1 of FIG. 10, since the log output function (1) is called at the error level=debug, in the flowchart of FIGS. 9A and B, the processing proceeds in the order of Step ST1→Step ST2→Step ST21→Step ST3→Step ST7 (since the error level is debug and the trigger level is error, it is No)→Step ST101 (since the error level is debug and the abnormal-time log output level is debug, it is Yes)→Step ST106→Step ST107→Step ST10 (since the error level is debug and the normal-time log output level is info, it is No)→Step ST11→Step ST12→Step ST13→Step ST14→Step ST15. Due to that the abnormal state flag is OFF, as well as the error level (debug) is not coincident with the normal-time log output condition (info) or the trigger level (error), no log output is made. However, since the error level is not less than the abnormal-time log output level, the log cache is added to the log output destination, and a log output is made to the log cache. At this time, the old log saved after the log cache saving period has passed is deleted from the cache.

At a check point 2 of FIG. 10, since a log output function (2) is called at the error level=info, in the flowchart of FIGS. 9A and B, the processing proceeds in the order of Step ST1→Step ST2→Step ST21→Step ST3→Step ST7 (since the error level is info and the trigger level is error, it is No)→Step ST101 (since the error level is info and the abnormal-time log output level is debug, it is No)→Step ST10 (since the error level is info and the normal-time log output level is info, it is Yes)→Step ST110→Step ST11→Step ST12→Step ST13→Step ST14→Step ST15. Due to that the error level (info) is coincident with the normal-time log output condition (info), the log cache and the general log file is added to the log output destination, and a log output to the log cache and the general log file is made.

At a check point 3 of FIG. 10, since a log output function (3) is called at the error level=error, in the flowchart of FIGS. 9A and B, the processing proceeds in the order of Step ST1→Step ST2→Step ST21→Step ST3→Step ST7 (since the error level is error and the trigger level is error, it is Yes)→Step ST8→Step ST9→Step ST901→Step ST902→Step ST91→Step ST92→Step ST61→Step ST10→Step ST110→Step ST11→Step ST12→Step ST13→Step ST14→Step ST15. Due to that the error level (error) is coincident with the trigger level, the abnormal-state flag is ON, and the present time is set be the abnormal-state start time. First, a log cache content is outputted to a log file for each error event, the log cache content is cleared, and thereafter the log file for each abnormal event is added to the log output destination. Thus, a log output is outputted to log file for each error event and the general log file.

Then, at a check point 4 of FIG. 10, a log output function (4) is called at the error level=debug. In case of normal time, debug is not coincident with the condition of info of the normal-time log output level, no log output is made. However, since the abnormal-time state flag is ON, as well as debug is coincident with the abnormal-state log output level, the processing of automatically making a detailed log output at the time of the occurrence of abnormality is operated to make a log output. That is, in the flow chart of FIGS. 9A and B, the processing proceeds in the order of Step ST1→Step ST2→Step ST21→Step ST3→Step ST4 (in the period of outputting the abnormal-time log)→Step ST6 (since the error level is debug and the abnormal-time log output level is debug, it is Yes)→Step ST61→Step ST10→Step ST110→Step ST11→Step ST12→Step ST13→Step ST14→Step ST15.

In the case that the abnormal-time log output period of the log output condition 11 continues up to a check point N of FIG. 10, since the log of which error level is not less than debug is coincident with the abnormal-time log output condition from the check point 3 to the check point N, a detailed log is outputted. When the abnormal-time log output period ends between the check point N and the check point N+1, that is, in the case that the time at the check point N+1 is on and after the abnormal-state start time+the abnormal-time log output period, in the flowchart of FIGS. 9A and B, operation proceeds in the order of Step ST1→Step ST2→Step ST21→Step ST3→Step ST4→Step ST5→Step ST7 (since the error level is debug and the trigger level is error, it is No), Step ST101 (since the error level is error, it is No)→Step ST101 (since the error level is debug and the abnormal-time log output level is debug, it is Yes)→Step ST106→Step ST107→Step ST10 (since the error level is debug and the normal-time log output level is debug, it is Yes)→Step ST110→Step ST11→Step ST12→Step ST13→Step ST14→Step ST15. Thus, although the abnormal-state flag is set to be OFF, and no log output is made, saving in the log cache is executed.

At a check point N+2 of FIG. 10, since error level=info is coincident with the log output condition at normal time, a log output is made in the same manner as at the check point 2.

As described above, according to this third embodiment, due to that a log can be outputted to separate log files for each abnormal event, it comes to be easy to determine whether or not it is the log related to an abnormal event on which attention is focused, resulting in an advantage of further improved maintainability of software.

While the presently preferred embodiments of the present invention have been shown and described, it is to be understood that these disclosures are for the purpose of illustration and that various changes and modifications may be made without departing from the scope of the invention as set forth in the appended claims.

What is claimed is:

1. A logging device for logging in real time data at a check point in execution of an application program,
wherein a log output condition that has preliminarily been externally set and that includes at least a normal-time log output level, an abnormal--time log output level and a trigger level, and a plurality of log output functions that are called at each check point and in which a parameter including at least an error level can be specified, are built in said application program; and at normal time, a log output is made only in the case that an error level having been specified with a parameter of a log output function is coincident with said normal-time log output level, and in the case that said error level that is coincident with said trigger level arises, a detailed log at the error level that is coincident with said abnormal-time log output level is outputted.

2. The logging device according to claim 1, wherein said log output condition includes an abnormal-state flag, an abnormal-time log output period and an abnormal-state start time in addition to said normal-time log output level, abnormal-time log output level and trigger level.

3. The logging device according to claim 2, wherein in the case of occurrence of an error level that is coincident with said trigger level, an abnormal-state flag is ON, and a present time is set to be an abnormal-state start time to make a log output; and when the abnormal-state flag is ON as well as said error level is coincident with an abnormal-state log output level, a detailed log output at the time of occurrence of abnormality is automatically made.

4. The logging device according to claim 1, wherein said normal-time log output level is an error level to be a log output condition in normal state, a trigger level is a log output level at which an abnormal state is determined, and an abnormal-time log output level is a log output level to be outputted when the abnormal state is determined by trigger level detection.

5. The logging device according to claim 1, wherein in the case of occurrence of an error level that is coincident with said trigger level, an abnormal-state flag is ON, and a present time is set to be an abnormal-state start time to make a log output; and when the abnormal-state flag is ON as well as said error level is coincident with an abnormal-state log output level, a detailed log output at the time of occurrence of abnormality is automatically made.

6. The logging device according to claim 1, wherein in the case of occurrence of an error level that is coincident with said trigger level, a log is saved in a log cache only for a predetermined saving period, a log output at an error level that is coincident with an abnormal-time log output level is made, as well as a log back before the occurrence of abnormality is outputted from the cache.

7. The logging device according to claim 6, wherein in the case of occurrence of an error level that is coincident with said trigger level, saving is made in separate log files for each abnormal event.

8. The logging device according to claim 1, wherein in the case of occurrence of an error level that is coincident with said trigger level, saving is made in separate log files for each abnormal event.

9. A recording medium that can be read by a computer in which a program which contains a log output condition that is stored in a data storage area and a plurality of log output functions that are called at each check point stored in a procedure storage area is recorded, and by which a log output level is automatically changed in such a manner that at normal time, only a log that is coincident with a log output level having been specified with said log output function is outputted, and at the time of occurrence of abnormality, a detailed log at an error level that is coincident with an abnormal-time log output level is outputted.
